(19) United States
(12) Patent Application Publication
(10) Pub. No.: US 2010/0193605 A1
(43) Pub. Date: Aug. 5, 2010

(54) THERMALLY BALANCED AERO STRUCTURES

(76) Inventors: Michael Robert Johnson, Loveland, OH (US); Rudolph Morris Tisdale, Waco, TX (US); Ronald Lance Galley, Mason, OH (US)

Correspondence Address: GENERAL ELECTRIC COMPANY, GE AVIATION, ONE NEUMANN WAY MD F16, CINCINNATI, OH, 45215, US

(21) Appl. No.: 12/363,295

(22) Filed: Jan. 30, 2009

(51) Int. Cl. F02K 1/00

(52) U.S. Cl. 239/265.11

(57) ABSTRACT

An aero structure includes inner and outer skins joined together by a core. The core has a different thermal conductivity than the inner skin to balance heat conduction therethrough.

### BACKGROUND OF THE INVENTION

The present invention relates generally to aero structures, and, more specifically, to aero structures such as exhaust nozzles and chevrons for gas turbine engines, and heat shields.

In a gas turbine engine, air is pressurized in a compressor and mixed with fuel in a combustor for generating hot combustion gases. Energy is extracted from the gases in a high pressure turbine (HPT) which powers the compressor, and, additional energy is extracted from the gases in a low pressure turbine (LPT) which powers an upstream fan in a turbofan aircraft engine application.

In the turbofan engine, a bypass duct surrounds the core engine and bypasses pressurized fan air through a fan nozzle for providing a large portion of propulsion thrust. Some of the fan air enters the core engine wherein it is further pressurized to generate the hot combustion gases which are discharged through the primary or core exhaust nozzle to provide additional propulsion thrust concentrically inside the surrounding fan air stream.

During takeoff operation of the engine in an aircraft, the high velocity core exhaust and fan exhaust generate significant noise as the exhaust flows mix with the ambient airflow. Noise attenuation in commercial aircraft engines is a significant design objective that may adversely impact engine efficiency, which is the paramount design objective in commercial aircraft.

The typical core and fan exhaust nozzles are conical and taper in diameter aft to thin, annular trailing edges. The nozzles may be single-ply sheet metal, or may be two-ply sheet metal with a honeycomb strengthening core laminated therebetween.

The nozzles are also typically formed as full, or substantially complete, annular rings which enhances their structural rigidity and strength for accommodating the large pressure loads developed during operation as the core and fan exhaust streams are discharged from the engine at high velocity.

A significant advancement in noise attenuation while maintaining aerodynamic efficiency is found in the chevron exhaust nozzle disclosed in U.S. Pat. No. 6,360,528, assigned to the present assignee. In this Patent, a row of triangular chevrons form the exhaust nozzle for enhancing mixing between the high velocity exhaust flow and the lower velocity surrounding stream. The individual chevrons are integrally formed at the aft end of a supporting annular exhaust duct and enjoy the combined structural rigidity and strength therewith.

However, since each chevron in the primary core nozzle is cantilevered over the hot exhaust flow, it is subject to large differential temperature over its radially opposite surfaces, especially during transient takeoff operation of the aircraft.

These differential temperatures can then effect temperature gradients radially through the chevron, with corresponding thermal distortion and stress depending on the particular chevron construction. And, the thermal distortion can significantly change the geometry of the nozzle and therefore affect both its aerodynamic performance and noise attenuation effectiveness.

For example, the cantilevered chevron is subject to undesirable tip curling of its aft apex end due to temperature gradients, and that curling changes the chevron geometry, including the effective flow area of the chevron nozzle.

By forming the chevrons in single-ply metal as found in the above-identified patent, the temperature gradients therein can be minimized, which in turn will minimize undesirable changes in nozzle geometry.

Single-ply construction for the primary exhaust nozzle requires a strong material having high strength at the high temperatures experienced during operation, and Titanium may therefore be used for that application.

However, Titanium metal is quite expensive and difficult to fabricate, and increases the cost of manufacture, although it also enjoys the benefit of low weight, which is especially important for aircraft engines.

Accordingly, it is desired to provide an improved aero structure such as a chevron exhaust nozzle for addressing these cost and operational problems.

### BRIEF DESCRIPTION OF THE INVENTION

An aero structure includes inner and outer skins joined together by a core. The core has a different thermal conductivity than the inner skin to balance heat conduction therethrough.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is a partly sectional, axial schematic view of an exemplary turbofan aircraft engine.

FIG. 2 is an isometric view of the primary core exhaust nozzle of the engine illustrated in FIG. 2 isolated therefrom.

FIG. 3 is an enlarged, partly sectional isometric view of a portion of the exhaust nozzle illustrated in FIG. 2.

FIG. 4 is an exploded, isometric view of a portion of the chevron exhaust nozzle illustrated in FIG. 3 and taken along line 4.4.

### DETAILED DESCRIPTION OF THE INVENTION

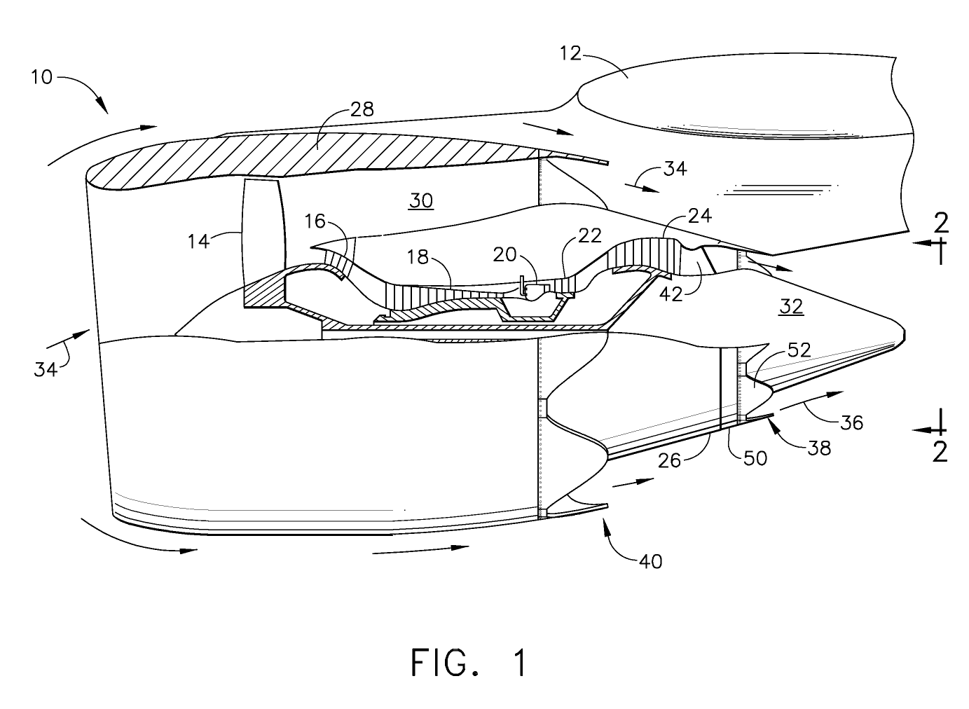

FIG. 1 illustrates an aircraft turbofan gas turbine engine 10 suitably joined to a wing of an aircraft 12 illustrated in part. The engine includes in serial flow communication a fan 14, low pressure compressor 16, high pressure compressor 18, combustor 20, high pressure turbine (HPT) 22, and low pressure turbine (LPT) 24 operatively joined together in a conventional configuration.

The engine also includes a core nacelle or cowl 26 surrounding the core engine and LPT, and a fan nacelle or cowl 28 surrounding the fan and the forward part of the core cowl and spaced radially outwardly therefrom to define a fan bypass duct 30. A conventional centerbody or plug 32 extends aft from the LPT and is spaced radially inwardly from the aft end of the core cowl.

During operation, ambient air 34 flows into the fan 14 as well as around the fan nacelle. The air is pressurized by the fan and discharged through the fan duct as fan exhaust for producing thrust. A portion of the air channeled past the fan is compressed in the core engine and suitably mixed with fuel and ignited for generating hot combustion gases 36 which are discharged from the core engine as core exhaust.

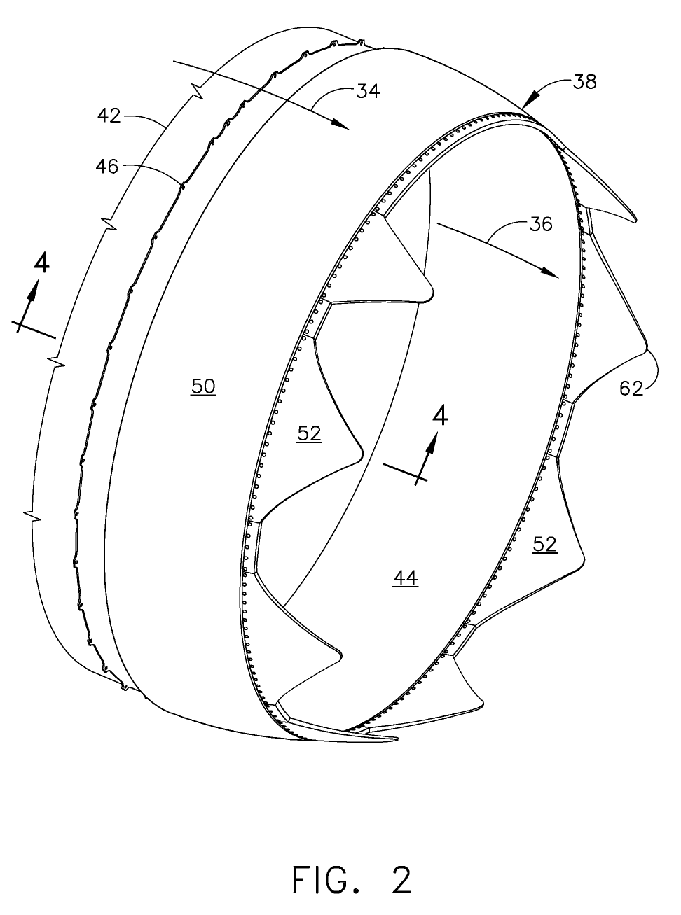

More specifically, the core engine includes an aero structure in the form of a primary or core exhaust nozzle 38 at the aft end thereof which surrounds the center plug 32 for discharging the core exhaust gases. The core nozzle 38 is generally axisymmetric about the axial centerline axis of the engine in the exemplary embodiment illustrated in FIGS. 1 and 2, and defines an improved chevron exhaust nozzle.

If desired, another form of aero structure such as the chevron exhaust nozzle may be used for the fan nozzle 40 at the aft end of the fan nacelle 28 for discharging the pressurized fan air around the core cowl 26 where it also meets and mixes with the ambient airflow as the aircraft is propelled during flight.

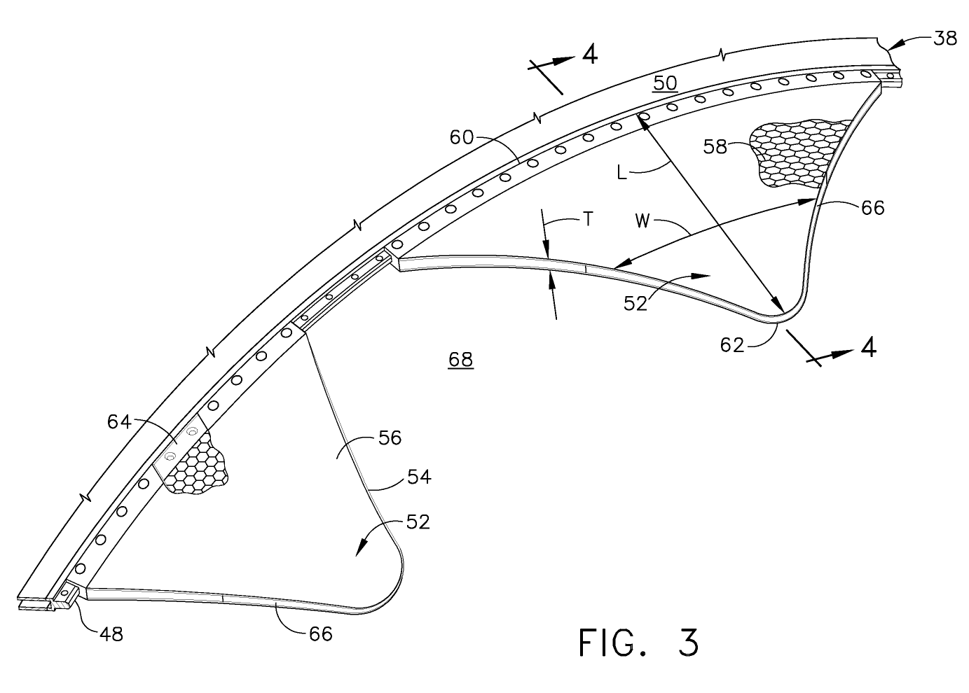

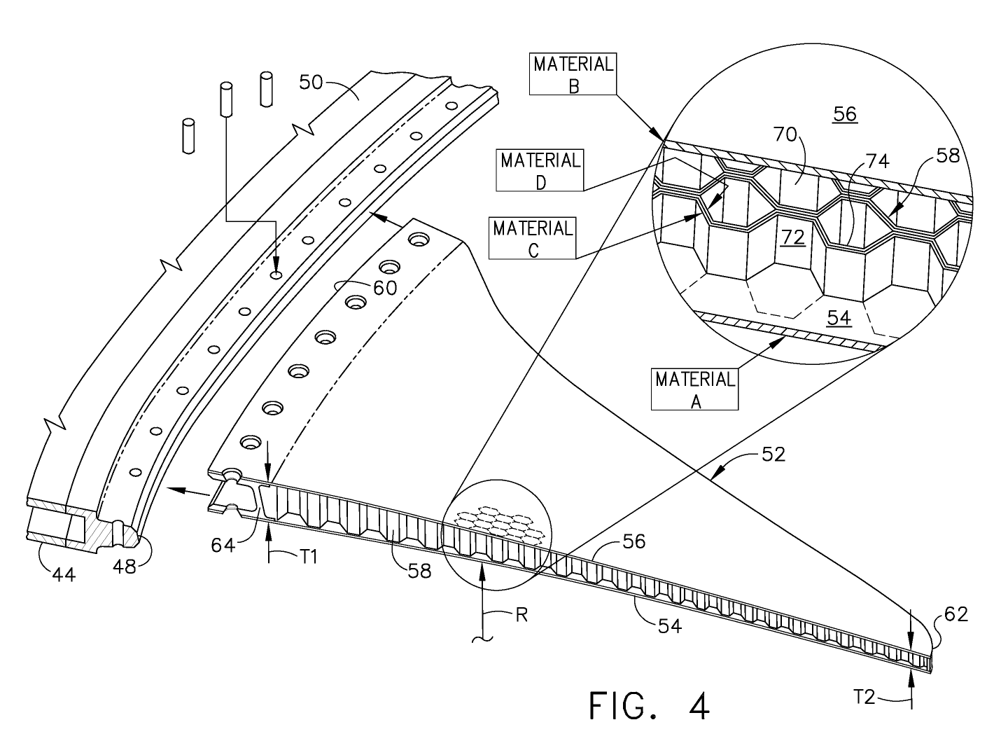

The primary exhaust nozzle 38 is illustrated in isolation in FIG. 2, with an enlarged portion thereof being illustrated in FIG. 3, and in exploded, axial view in FIG. 4. And, the primary nozzle 38 is suitably joined to the turbine rear frame 42 as shown in FIG. 1.

More specifically, the nozzle 38 includes an annular exhaust duct 44 having an annular mounting flange 46 integrally formed at the forward end thereof as illustrated in FIG. 2. The mounting flange 46 is used to conventionally mount the exhaust duct to a portion of the turbine rear frame 42.

The exhaust duct 44 extends axially aft and terminates in a converging cone portion for discharging the core exhaust 36 around the center plug 32 as shown in FIG. 1. The aft end of the exhaust duct has an annular support flange 48 shown in FIG. 4, which increases the structural rigidity and strength of the exhaust duct.

An annular fairing 50 surrounds the duct 44 and is spaced radially outwardly therefrom, and terminates therewith at the common support flange 48. The fairing 50 increases in outer diameter in the upstream direction from the aft support flange 48 and suitably blends flush with the aft end of the core cowl 26 to provide an aerodynamically smooth surface over which the fan air 34 is discharged.

The aft ends of the exhaust duct 44 and the fairing 50 where they join the common annular support flange 48 is best illustrated in FIG. 4. The duct and fairing are made of relatively thick sheet metal of about 63 mils (1.6 mm) thickness and are integrally joined, by welding for example, to corresponding inner and outer legs of the common support flange 48.

The collective assembly of these three elements provides a full annular ring of considerable rigidity and strength, all of these components being suspended in turn from the common mounting flange 46 attached to the turbine rear frame.

The common annular support flange 48 initially illustrated in part in FIG. 3 provides a convenient and strong support for mounting to the aft end of the exhaust duct at least one chevron, and typically a plurality of chevrons such as a full row of modular chevrons 52 which may be suitably fixedly joined to the support flange 48 in various manners.

FIG. 2 illustrates eight modular chevrons 52 in varying width or size found in the primary nozzle 38, and FIGS. 3 and 4 illustrate common features thereof.

More specifically, each chevron 52 is a dual skin fabrication including a radially inner skin 54 and a radially outer skin 56 having similar triangular configurations. The two skins are laminated together by a hollow structural core 58 extending radially therebetween.

For the primary nozzle configuration, the two skins may be formed of conventional, thin sheet metal for providing smooth aerodynamic surfaces. And, the core itself may also be formed of thin sheet metal for reducing weight while maintaining strength.

The skins and core may be made of metal alloys suitable for withstanding the high temperature of the core gases 36, and may be conventionally brazed together in an integrally joined unitary assembly for enhanced rigidity and strength. The so bonded assembly of metal components ensures a direct thermal path from the inner skin and through the core to the outer skin for thermally conducting heat therethrough.

The chevrons 52 share common configurations in different sizes as desired, including a circumferentially or laterally wide base end 60 and decrease laterally in width W to a preferably arcuate apex 62 at the opposite aft end thereof to define the triangular profile thereof as illustrated in FIG. 3.

The two skins are fixedly joined together on opposite sides of an arcuate base flange 64 shown in FIG. 4, by brazing for example, which flange 64 rigidly mounts each chevron to the common support flange 48.

Each chevron 52 illustrated in FIG. 3 therefore commences at the common support flange 48 with a wide base 60 and decreases in width W along the trailing edge 66 thereof which terminates in the preferably round apex 62 at the aft end of the chevron.

Correspondingly, as the individual chevrons converge in width in the downstream direction, diverging slots 68 are defined between adjacent chevrons and increase in lateral width in the downstream direction along the opposite portions of opposing trailing edges of the chevrons.

As shown in FIG. 3, the hollow core 58 preferably extends over the entire triangular configuration of the chevron behind the support flange 48. The chevron is preferably bound by a continuous rim that extends along, and defines, the trailing edge 66 of each chevron and defines with the support flange 48 a full perimeter of each chevron between the base and apex. The thin skins 54,56 are therefore rigidly joined together by the core 58, rigid base flange 64, and the bounding rigid trailing edge rim 66.

Each chevron is therefore an aero structure which is a modular or unitary assembly of individual subcomponents which may be conveniently manufactured independently of the entire primary nozzle. The individual chevrons share the common modular features of dual skins, core, support flange, and perimeter rim, yet may conveniently vary in size for maximizing aerodynamic performance of the entire complement of chevrons in the nozzle.

Since each chevron 52 illustrated in FIG. 3 has a triangular configuration for enhanced mixing performance and noise attenuation, they converge laterally in circumferential width W across the longitudinal or axial length L of the chevron between the wide base 60 and narrow apex 62. Furthermore, each chevron 52 preferably tapers or decreases in radial thickness T between the base flange 48 and the apex 62.

The lateral or circumferential taper is best illustrated in FIG. 3, and the radial or transverse taper is best illustrated in FIG. 4. Since the entire chevron 52 is supported at its upstream base flange 64, it is cantilevered therefrom and the tapered box construction of the duel skins increases rigidity and strength thereof while correspondingly reducing weight.

Each skin is preferably thin sheet metal having a nominal thickness of about 12 mils (0.30 mm) which is substantially thinner than the thickness of the exhaust duct 44 and fairing 50 which integrally support the support flange 48.

And, the thickness T of the chevron has a maximum value T1 as illustrated in FIG. 4 at the base end of the chevron and decreases in thickness to the minimum thickness T2 at the apex 62. The maximum thickness T1 may be about 440 mils (11 mm), and the minimum thickness T2 may be about 100 mils (2.5 mm), with the thickness decreasing smoothly therebetween.

FIG. 2 illustrates the external flow of the fan exhaust 34 and the internal flow of the core exhaust 36 which produce a net aerodynamic pressure force on each of the cantilevered chevrons. The pressure force in turn effects a counterclockwise torque or moment acting across the chevron which is in turn carried by the base flange 64 thereof.

The aerodynamic moment loads are in turn carried from the base flange 64 into the annular support flange 48, and in turn carried upstream along the exhaust duct 44 to the turbine rear frame.

As initially shown in FIG. 3, the modular chevron 52 provides an aerodynamically smooth continuation of the exhaust duct and its surrounding fairing 50 for enjoying the performance and noise attenuation benefits of the original single-ply chevron nozzle. In addition, the individual chevrons may be premanufactured and assembled to complete the entire primary nozzle having manufacturing advantages not practical in fully annular or unitary nozzle constructions.

Each chevron 52 illustrated in FIG. 3 is arcuate circumferentially with a corresponding convex outer skin and a concave inner skin.

Furthermore, each chevron may additionally be arcuate in the axial or longitudinal direction for providing the compound arcuate or bowl configuration of the original single-ply chevrons. In particular, the chevron inner skin 54 has a radius of curvature R in the axial plane or section illustrated in FIG. 4 so that the inner skin is additionally axially concave as well as circumferentially concave.

Correspondingly, the outer skin 56 is similarly axially convex outwardly in addition to being circumferentially convex outwardly.

The compound curvature of the inner and outer skins 54,56 may be used to advantage for maximizing aerodynamic performance, with the additional design variable of varying the radial thickness T of the chevron between its base or root end where it is mounted on the common support flange 48 to its aft or distal end at the corresponding apex 62.

In the preferred embodiment illustrated in the several Figures, the thickness T of the chevron remains constant in the circumferential direction while varying or tapering thinner in the axial direction between the base and apex ends thereof.

To further enhance the strength of the individual chevrons 52, the hollow core 58 is in the preferred form of a metal honeycomb laminated, by brazing for example, between the dual skins 54,56 as shown in FIGS. 3 and 4. The honeycomb includes hexagonal voids or hollow cells 70 which extend radially or transversely to bridge the skins.

The honeycomb core 58 preferably extends over substantially the entire surface area of the laminated skins illustrated in FIG. 3 axially from the base flange 64 aft to the chevron apex 62 and circumferentially between the laterally opposite sides of each chevron along the trailing edge 66 immediately inside the bounding rim.

A preferred embodiment of the chevron trailing edge rim 66 is illustrated in FIG. 3 and includes a thin solid sheet metal strip facing outboard between the two skins and recessed slightly therewith. The honeycomb core 58 may have a hexagonal cell size of 250 mils (6.3 mm), and is laterally bound by the perimeter rim 66 rigidly joined thereto.

The honeycomb core and sheet metal rim may be brazed to the inner and outer skins to form a unitary and modular chevron with enhanced rigidity and strength, while still being exceptionally lightweight.

FIG. 4 illustrates axial assembly of one of the chevrons 52 to engage the grooved flange 64 over the complementary tongue of the supporting flange 48, with FIG. 3 showing the final assembly of the joint therebetween.

Each chevron 52 includes a row of apertures extending transversely or radially through the skins and base flange 64, and aligned with corresponding apertures through the support flange 48. Individual fasteners, such as conventional rivets, may be used in each aperture to fixedly and independently mount each of the chevrons on the support flange 48 with the tongue-and-groove joints therewith.

Accordingly, each chevron 52 is securely mounted to the annular supporting flange 48 at the aft end of the exhaust duct 44 and suitably mixes the hot core exhaust 36 with the cooler fan exhaust 34 for attenuating noise during operation.

Since each chevron is cantilevered from the common supporting flange 48, it independently withstands the substantial pressure loads exerted radially thereacross.

However, the large radial temperature difference between the hot core exhaust 36 and cool fan exhaust 34 subjects the cantilevered chevrons to the undesirable tip curling problem disclosed in the Background section.

In particular, the hot inner skin 54 tends to thermally expand greater than the thermal expansion of the cooler outer skin 56, which differential expansion can result in substantial tip curling in the laminated chevron configuration disclosed above when the components thereof are made from a single metal alloy.

Development testing has shown that tip curling of the chevron can significantly alter nozzle geometry, and therefore reduce nozzle aerodynamic performance and efficiency, and, significantly reduce noise attenuation of the chevron nozzle itself Tip curling will be most pronounced under transient operation of the engine where exhaust temperature changes are greatest, but can also occur during steady state operation, such as cruise, whenever temperature gradients are effected across the chevrons.

To minimize and correspondingly control the differential thermal expansion of the chevron skins, those skins, and the honeycomb core, are preferably made from selectively different materials illustrated schematically in FIG. 4 as materials A, B, and C, for example. Each material is preferably a metal or metal alloy suitable for withstanding the high temperature environment of the core nozzle 38, and has correspondingly different material compositions, and material properties, including in particular different thermal performance.

More specifically, since the core 58 itself is hollow for reducing chevron weight, while nevertheless maintaining strength and rigidity thereof, it necessarily separates radially the two skins over the requisite radial thickness T of the chevron and therefore effects a substantial radial temperature gradient through the chevron, especially in transient operation corresponding with aircraft takeoff where most noise attenuation is desired.

That temperature gradient in turn creates corresponding thermal strain and stress, and subjects the two skins to correspondingly different thermal expansion during operation which can lead to the undesirable tip curling problem and change of nozzle flow area geometry.

However, by preferentially selecting the core material, C for example, to be different than the material A of the inner skin 54, thermal conduction through the core 58 may be preferentially controlled.

For the core nozzle 38, it is desirable to incorporate a core material C having a thermal conductivity greater than that of the inner skin 54 for significantly increasing the thermal conduction from the inner skin 54 and through the core 58 to the outer skin 56, which in turn better balances heat distribution throughout the chevron. The core may comprise a structural portion and a conductive portion, with the conductive portion having a greater thermal conductivity than both inner and outer skins.

In this way, the temperature gradient between the two skins, and core, can be significantly reduced, and the thermal expansion of the outer skin 56 may be increased to better match the thermal expansion of the inner skin 54, and thereby reduce the differential expansion therebetween, and thusly minimize the undesirable tip curling. Accordingly, aero structures such as nozzles, chevrons, heat shields, or the like may be fabricated from a thermally balanced material having inner and outer skins and a core.

Thermal conductivity is one common material property of a metal, and is expressed in Watts per meter-degree(K), at room temperature for example; and the Coefficient of Thermal Expansion (CTE), expressed in mm per mm-degree(F.), is another common material property that is indicative of increasing length or expansion as temperature rises.

For a common material and common temperature, the resulting thermal expansion will be the same. However, for the common material and different temperatures, the resulting thermal expansion will be different.

Accordingly, independently of the particular material compositions of the two skins, be they the same or different, if the difference in operating temperatures thereof is reduced, then the difference in thermal expansion thereof will correspondingly be reduced, and this can be used to effectively reduce the undesirable tip curling of the chevron.

The higher thermal conductivity core 58 in conjunction with the lower thermal conductivity inner skin 54 in particular, as well as the lower thermal conductivity outer skin 56, may be used to particular advantage in reducing the undesirable tip curling of the modular chevron during transient operation, as well as during steady state operation. Thus, thermally balanced materials such as those described herein may be utilized to fabricate thermally balanced aero structures, such as exhaust nozzles, chevrons, heat shields, etc., with desirable thermal geometric properties.

Since the core 58 is integral to the collective strength of the modular chevron 52, that core 58 must have sufficient strength, notwithstanding the desire to increase its thermal conductivity. In other words, increased thermal conductivity must not be effected with any undesirable decrease in core strength.

Accordingly, one configuration for selectively increasing thermal conductivity of the core 58 is to form the honeycomb thereof in two, or more, plies. FIG. 4 illustrates one embodiment in which the honeycomb core 58 has laminated first and second plies 72,74 which together define the hexagonal walls bounding each of the hexagonal cells 70.

Each of the two plies 72,74 is preferably thin sheet metal with different material compositions, with the first ply 72 being made from material C and the second ply being made from a different material D.

In particular, the first ply 72 has a thermal conductivity substantially greater than the thermal conductivity of the inner skin 54, as well as that of the outer skin 56 and the second ply 74.

The different metal components of the chevron 52 may therefore be formed of different materials having different material compositions and different material properties individually selected for enhancing strength of the modular chevron while minimizing undesirable changes in geometry thereof due to temperature gradients therein.

At least one of the honeycomb plies 72,74 preferably has the higher thermal conductivity than the inner skin 54, although higher thermal conductivity of the core 58 may otherwise be introduced therein. The advantage of the higher thermal conductivity first ply 72 is the simplicity of maintaining the honeycomb configuration for low-weight strength thereof, with the first ply 72 providing primarily the increased thermal conduction and the second ply 74 providing the requisite strength.

The two-ply honeycomb core 58 may be readily fabricated in sheet metal like the sheet metal skins 54,56. The two plies 72,74 may be laminated into half-cell strips, and the half-cell strips may abut each other, at four plies, to form the hexagonal cells.

The honeycomb strips are sandwiched between the two skins and bonded together by conventional brazing into an integrated and unitary module. Full surface braze joints are formed laterally between the abutting core plies 72,74 themselves, with corresponding braze joints between the edges of the plies and the bounding skins 54,56.

The use of selectively different materials for aero structures such as the chevron components may be used for additional advantage to further improve thermal response, and further decrease undesirable tip curling if desired.

For example, the two skins 54,56 may selectively have different coefficients of thermal expansion, with the outer skin 56 have a greater CTE than the inner skin 54.

For the core nozzle 38 configuration illustrated in FIG. 4, the chevrons 52 bound the hot core exhaust 36 while themselves being bound or bathed in the substantially cooler fan exhaust 34. The operating temperature of the inner skin 54 is therefore higher than that of the outer skin 56, especially during transient operation like takeoff.

Accordingly, by using a higher or greater coefficient of thermal expansion for the cooler outer skin 56, that outer skin 56 will thermally expand more than it otherwise would, and thereby reduce the differential expansion with the hotter inner skin 54.

The effect of different CTE for the two skins complements the higher thermal conductivity of the core, and collectively these two effects may be used to tailor the resulting tip curl of the chevron. Significant reduction in the curl, which would otherwise be effected for identical material throughout the chevron, may be obtained by selecting different materials as described above, with tip curl reduction being reduced to about zero if desired, or even having tip curl reversing direction from radially out to radially in, if so desired.

In one embodiment analyzed, total tip curl, measured by radial displacement at the tip or apex 62 of the chevron, could be as large as about 5 percent of the chevron length for a single-material chevron. But, for the multiple-material chevrons disclosed above, that tip curl could be reduced to a few mils, or zero, in the radially outwardly direction, and even reversed to the radially inward direction in a magnitude approaching −1 percent.

Accordingly, the thermal effects of material selection for the modular chevron are pronounced and allow further variation in chevron design at desired design points like takeoff or cruise for example.

Since the core nozzle 38 is subject to the high temperatures of the core exhaust 34, the multiple materials of the modular chevron 52 may be used to advantage to balance thermal performance thereof, and preferentially reduce the undesirable tip curl.

Inconel (or Inco) is a nickel-based metal alloy commonly used in the production of modern gas turbine engines, especially for components thereof exposed to the hot combustion gases. It is less expensive than Titanium, but does not enjoy the strength-to-weight advantage of Titanium.

The chevrons may nevertheless be manufactured from Inconel in multi-ply sheet metal modular form for replacing the more expensive single-ply Titanium chevrons disclosed above.

For example, the inner and outer skins 54,56 may be formed of Inco 625 or AMS 5599 which has a thermal conductivity of 9.8, and a CTE of 7.1×10⁻⁶, which material is less expensive that Titanium.

For further reducing cost, the outer skin 56 may also be formed of a suitable stainless steel, like AISI 347, which has a thermal conductivity of 16; and a CTE of 9.6×10⁻⁶, which is still suitably larger than the CTE of the inner skin.

The inner skin 54 may also be formed of other materials, like Inco 909, having a thermal conductivity of 14.8.

The honeycomb core 58 may be formed of a suitably different material, like copper for the first ply 72 for its large thermal conductivity of 385, while the second ply 74 being Inco 625 with its smaller thermal conductivity of 9.8. However, the combined thermal conductivity of the two different core plies 72,74 is still quite large at about 197, and is effectively larger than that of the inner skin 54.

In one combination of materials having enhanced performance for the core nozzle 38, material A for the inner skin is Inco 625, material B for the outer skin 56 is AISI 347, material C for the first core ply 72 is two mil (0.05 mm) thick copper, and the material D for the second core ply 74 is two mil (0.05 mm) thick Inco 625.

This combination of materials results in a modular chevron 52 of the core nozzle 38 having negligible tip curl during the transient takeoff operating condition.

And, different material combinations may be used for different operating conditions and operating environments as desired.

Since the chevron fan nozzle 40 illustrated in FIG. 1 bounds the pressurized fan exhaust 34, the temperature difference with the external ambient air is less than that for the core nozzle.

Nevertheless, the modular chevrons for the fan nozzle 40 may also be formed with suitably different materials, additionally including composite materials, for reducing changes in geometry thereof during operation.

The modular configuration of the individual chevrons 52 disclosed above provides strong, lightweight chevron modules which may be conveniently and economically premanufactured individually for later assembly. The common support flange 48 provides a fully annular supporting structure having enhanced rigidity and strength to which the individual modular chevrons may be attached or removed as desired.

The modular configuration of the chevrons also permits the use of different materials in the fabrication of the different components thereof, from the preferred multiple metal configurations disclosed above to advanced composite materials if desired. Such multiple materials may therefore be used to thermally balance operating temperatures and reduce thermal stress, distortion, and undesirable tip curl.

While much of the foregoing discussion has focused on exhaust nozzles and chevrons for gas turbine engines, it should be understood that the multilayer materials described herein may be employed in the fabrication of a wide variety of other structures, including but not limited to aero structures such as the exhaust nozzles and chevrons described herein but also to heat shields and other structures where the thermal balance and stability provided by such materials may be employed to advantage.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims in which we claim:

1. An aero structure comprising:
inner and outer skins integrally joined together by a core therebetween; and
said core having a different thermal conductivity than said inner skin.

2. A structure according to claim 1, wherein said structure is an exhaust nozzle.

3. A structure according to claim 1, wherein said structure is a chevron.

4. A structure according to claim 1, wherein said structure is an exhaust nozzle which includes at least one chevron.

5. A structure according to claim 1, wherein said inner skin, outer skin, and core comprise sheet metal bonded together for thermally conducting heat from said inner skin and through said core to said outer skin.

6. A structure according to claim 1, wherein said core comprises a honeycomb having hollow cells bridging said inner and outer skins.

7. A structure according to claim 1, wherein said core comprises a structural portion and a conductive portion, with said conductive portion having a greater thermal conductivity than both said skins.

8. A structure according to claim 1 wherein said inner skin, outer skin, and core include different material compositions.

9. An exhaust nozzle comprising:
a row of chevrons fixedly joined to an annular exhaust duct;
each of said chevrons including radially inner and outer skins converging along a trailing edge between a forward base and an aft apex; and
said skins being laminated to a corresponding core in each chevron, with said core having a greater thermal conductivity than said inner skin, and said outer skin having a greater coefficient of thermal expansion than said inner skin.

10. A nozzle according to claim 9 wherein each of said chevrons converges both in circumferential width and radial thickness axially between said base and apex.

11. A nozzle according to claim 10 wherein said inner skin, outer skin, and core comprise sheet metal bonded together for thermally conducting heat from said inner skin and through said core to said outer skin.

12. A nozzle according to claim 11 wherein said core comprises a honeycomb having hollow cells bridging said inner and outer skins.

13. A nozzle according to claim 12 wherein said inner and outer skins are arcuate both axially and circumferentially, and said honeycomb core bridges said skins radially therebetween.

14. A nozzle according to claim 9, wherein said core comprises a structural portion and a conductive portion, with said conductive portion having a greater thermal conductivity than both said skins.

15. A nozzle according to claim 9 wherein said inner skin, outer skin, and core include different material compositions.

16. An exhaust chevron comprising:
inner and outer skins integrally joined together by a core therebetween; and
said core having a different thermal conductivity than said inner skin.

17. A chevron according to claim 16 wherein said outer skin has a different coefficient of thermal expansion than said inner skin.

18. A chevron according to claim 17 wherein:
said core has a greater thermal conductivity than said inner skin; and
said outer skin has a greater coefficient of thermal expansion than said inner skin.

19. A chevron according to claim 18 wherein said inner and outer skins converge in lateral width along a trailing edge longitudinally between a base and an opposite apex, and are laterally arcuate.

20. A chevron according to claim 19 wherein said inner and outer skins are longitudinally arcuate between said base and apex, and converge in transverse thickness.

21. A chevron according to claim 19 wherein said core comprises a honeycomb laminated between said skins with correspondingly different material compositions.

22. A chevron according to claim 16 wherein said core comprises a structural portion and a conductive portion, with said conductive portion having a greater thermal conductivity than both said skins.

23. A plurality of chevrons according to claim 20 arranged in a row and fixedly joined at said bases thereof to an annular supporting flange, with said inner skins facing radially inwardly.

24. A exhaust nozzle comprising a row of chevrons each having a radially inner skin and a radially outer skin laminated together by a core radially therebetween with different material compositions thereof.

25. A nozzle according to claim 24 wherein:
each of said chevrons converges in circumferential width axially along a trailing edge between a forward base and an opposite, aft apex; and
said inner and outer skins are axially concave and convex, respectively, between said base and apex.

26. A nozzle according to claim 24 wherein said core comprises a honeycomb laminated between said skins, and has a greater thermal conductivity than said inner skin.

27. A nozzle according to claim 26 wherein said outer skin has a greater coefficient of thermal expansion than said inner skin.

28. A nozzle according to claim 24 wherein said core comprises a structural portion and a conductive portion, with said conductive portion having a greater thermal conductivity than both said skins.
